(19) United States
(12) Patent Application Publication
(10) Pub. No.: US 2015/0293949 A1
(43) Pub. Date: Oct. 15, 2015

(54) DATA SAMPLING DEDUPLICATION

(71) Applicant: Mark David Lillibridge, Mountain View, CA (US)

(72) Inventor: Mark David Lillibridge, Mountain View, CA (US)

(21) Appl. No.: 14/367,880

(22) PCT Filed: Mar. 8, 2012
(86) PCT No.: PCT/US2012/028200

§ 371 Date: Jun. 20, 2014

(51) Int. Cl. G06F 17/30

(52) U.S. Cl. CPC G06F 17/30303; G06F 17/30321

(57) ABSTRACT

Techniques for deduplication include receiving a series of data blocks that includes a first data block and deciding whether the first data block is a sampled data block. If the first data block is a sampled data block and information about the first data block is not in a index, storing information about the first data block in the index. If the first data block is not a sampled data block and information about the first data block is not in the index, deciding whether to store information about the first data block in the index based in part on whether it is near data blocks whose Information is stored in the index.

### BACKGROUND

Data deduplication refers to techniques for elimination of redundant data. In the deduplication process, duplicate data is deleted, leaving only one copy of the data to be stored. Deduplication may be able to reduce the required storage capacity because only unique data is stored.

### BRIEF DESCRIPTION OF THE DRAWINGS

FIG. 1 is an example block diagram of a computer system with data sampling deduplication.

FIG. 2 is a flow diagram of an example method of processing data blocks using data sampling deduplication.

FIGS. 3A-3C are diagrams showing an example of data being processed by a computer system having data sampling deduplication.

FIG. 4 is a block diagram showing a non-transitory, computer-readable medium that stores instructions for providing a method of processing data using data sampling deduplication in accordance with an example.

### DETAILED DESCRIPTION

The present application discloses deduplication techniques to help reduce redundant data. In one example, disclosed are techniques that include storing information of a data block in an index based in part on a whether the data block is a sampled data block. Determination of whether a data block is a sampled data block can include checking whether it has a predetermined characteristic, which can be deterministic and based on a hash value of the data block.

In one example, the techniques can include receiving a series of data blocks that includes a first data block and deciding whether the first data block is a sampled data block. In one example, the decision about whether the data block is a sampled data block can be made by checking whether a hash value of the first data block has a predetermined characteristic. If the first data block is a sampled data block and information about the first data block is not in the index, then information about the first data block is stored in the index. If the first data block is not a sampled data block and information about the first data block is not stored in the index, then a decision is made whether to store information about the first data block in the index based in part on whether it is near data blocks whose information is stored in the index. By the term “near” as used herein, we mean that the distance between the two blocks in question in the series of data blocks is small. In cases where data stream 102 consists of a series of consecutive data blocks to be stored sequentially, the distance may simply be how many data blocks separate the two blocks in question. In other cases where data stream 102 consists of a series of data blocks with logical addresses they should be stored to, distance may be defined as the distance between the logical addresses. Other ways of defining distance are possible. In this manner, the decision about which data blocks should have their information stored in the index can be based on a combination of predetermined characteristics of the data blocks and the locality of the data blocks.

These techniques for making decisions whether to store information in the index may help reduce the size of the index because only a percentage of the data blocks will have their information stored in the index compared to a technique that stores information for all of the data blocks that it receives in the index. As explained in further detail below, because of these techniques for making decisions about storing information about data blocks in the index, as more of the same data blocks are received, then more of the data blocks may have their information stored in the index, and therefore more of the data blocks may be deduplicated. In other words, if the technique receives a data block and finds that information about the data block is already stored in the index, then the data block is a duplicate meaning that a copy of the data block has already been stored in a storage system. Furthermore, rather than making an additional copy of the data block in the storage system, the technique can make reference to the stored copy of the data block in storage.

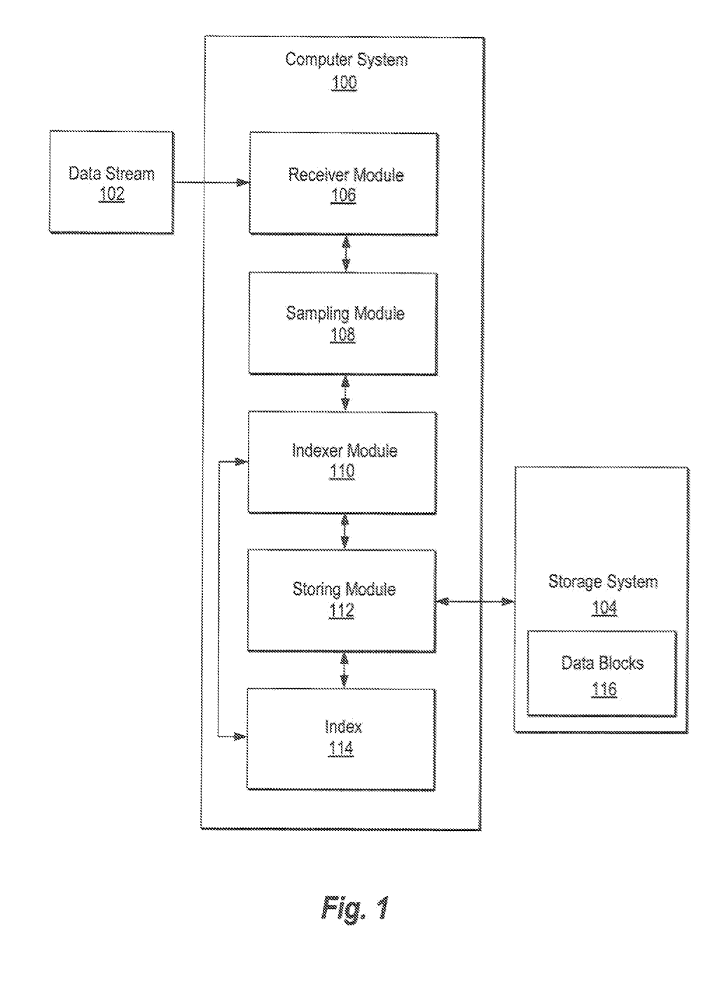

FIG. 1 is an example block diagram of a computer system 100 for data sampling deduplication. The computer system 100 includes a receiver module 106, which can receive from a data stream 102 data such as a series of data blocks. In some examples, the data stream 102 arrives to computer system 100 as a sequence of bytes and is then chunked into a series of data blocks, which are then received by receiver module 106. The computer system 100 includes a storing module 112 that can store selected data blocks of the received data as data blocks 116 in storage system 104. In some examples, storage system 104 may be part of computer system 100 and in other examples, it may be separate but coupled to computer system 100 by a means such as a network.

The computer system 100 includes a sampling module 108 to decide whether the data blocks received from data stream 102 are sampled data blocks. For example, sampling module 108 can decide whether a data block is a sampled data block by checking whether a hash value of that data block has a predetermined characteristic. The predetermined characteristic can be a deterministic characteristic of the hash value such as hash=0 mod N for some fixed N.

In addition, computer system 100 includes an indexer module 110 to decide which of the received data blocks from data stream 102 should have information about them stored in an index 114. For example, indexer module 110 can check whether information about one of the received data blocks is stored in index 114. In another example, indexer module 110 can check whether a data block is a sampled data block and whether information about the data block is stored in index 114. If indexer module 110 determines that a data block is a sampled data block and information about the data block is in not stored in index 114, then it can store information about the data block in the index.

On the other hand, if indexer module 110 determines that a data block is not a sampled data block and information about the data block is not stored in index 114, then it can decide whether to store information about the data block in the index based in part on whether it is near data blocks whose information is stored in the index. Information about the data block can include a hash value of the data block. Information about the data block can also include location information about the data block such as a pointer to or a physical address of a location where the data block has been stored in storage such as storage system 104.

The indexer module 110 can be configured to determine location (locality) related information about data blocks relative to other data blocks stored in index 114. For example, indexer module 110 can decide whether a data block is near other data blocks whose information is stored in index 114 by checking whether the data block is within a predetermined distance of a data block of one of the series of data blocks whose information is in the index. The indexer module 110 may accomplish this by checking all the data blocks of the series of data blocks that are within the predetermined distance of the given data block to determine if they have information in the index about them.

In another example, indexer module 110 can decide whether a data block is near other data blocks that are stored in index 114 by checking whether the data block is near at least a predetermined number of data blocks of the series of the data blocks whose information is stored in the index. These location related parameters, such as the predetermined distance or predetermined number of data blocks, can be include any number of data blocks such, as ten data blocks, and can be based on various factors related to the characteristics of the data blocks or the stream of data blocks.

As described above, indexer module 110 can store information about data blocks in index 114. In another example, indexer module 110 can also remove information about one or more data blocks previously stored in index 114 by the indexer module. In one example, indexer module 110 can remove information of non-sampled data blocks from index 114 if their information has been stored in the index for more than a predetermined period of time. In another example, indexer module 110 can remove the information of randomly chosen non-sampled data blocks from index 114. These removal techniques can help prevent the size of the index from becoming too large and thereby help reduce excessive memory capacity requirements, for example.

As explained above, computer system 100 can store the received data stream as data blocks 116 in storage system 104. In one example, indexer module 110 can first receive data blocks from data stream 102 and decide which of the data blocks to store information about in index 114. Then, storing module 112 can store copies of the data blocks about which information was not found in index 114 as data blocks 116 in storage system 104. To facilitate retrieval of data blocks from storage system 104, computer system 100 or storage system 104 can include a table of logical-to-physical address pointers. The logical address can represent a logical address of the location of one of the stored data blocks while the physical address can represent a physical address of the location of a copy of that data block stored on a physical medium of storage system 104. The table can provide a mechanism to track the location of the stored data for subsequent retrieval. For example, computer system 100 can receive from a source, such as another computer, a request to retrieve the data block at a given logical address. The request can include a logical address of the data block. In one example, storing module 110 can use the logical address to look in the logical-to-physical address table to find the physical address corresponding to the logical address. Once the physical address is found, storing module 112 can use the physical address to retrieve the desired data block from storage system 104 and return it to the source of the request. Although storing module 112 is described as being able to perform the functionality of storing data blocks to storage system 104, it should be understood that another module, such as indexer module 110, can be used to perform such functionality.

The receiver module 106 is shown as being operatively coupled to data stream 102. In one example, receiver module 106 can provide a block interface to receive data blocks from data stream 102 and to store the data as data blocks 116 on storage system 104. In another example, receiver module 106 can provide a file system interface to receive files or file updates from data stream 102 and to store the files or file changes in storage system 104, possibly in the form of data blocks 116. In another example, receiver module 106 can provide a combination of block and file system interfaces. In another example, although receiver module 106 is shown receiving data from data stream 102, it should be understood that another module, such as storing module 106, can retrieve data from storage system 104 and provide the retrieved data as a data stream of data blocks to external devices coupled to computer system 100.

The computer system 100 is shown as a single computing device. However, it should be understood that computer system 100 can comprise a plurality of computing devices located centrally, distributed over wide geographical locations, or a combination thereof. The computer system 100 can be any electronic device capable of data processing. For example, computer system 100 can be a server computer, a client computer, a mobile device, and the like.

The storage system 104 is shown as a single storage element. However, it should be understood that storage system 104 can include a plurality of storage elements located centrally, distributed over wide geographical locations, or a combination thereof. The storage system 104 can be any electronic device capable of storing data for subsequent retrieval. For example, storage system 104 can be one or more disk drives, optical drives, non-volatile memory, and the like. The computer system can be part of a network such as a storage area network (SAN), local area network (LAN), network attached storage (NAS), and the like.

The data stream 102 is shown as a single source of data. However, it should be understood that data stream 102 can include a plurality of data streams located centrally, distributed over wide geographical locations, or a combination thereof. The data stream 102 is shown as a source of data from outside computer system 100. However, it should be understood that data stream 102 can include functionality to receive data from computer system 100 itself.

Although storage system 104 is shown separate from computer system 100, it should be understood that the storage system can be integrated with the computer system 100 as part of a single physical structure such as a storage chassis, for example. Although the functionality of computer system 100, such as indexer module 110, is shown as being part of the computer system, it should be understood that such functionality can be distributed among other computer systems. It should be understood that the functionality of computer system 100 can be implemented in hardware, software, or a combination thereof.

The deduplication techniques of the present application may be applicable to various computer system environments. For example, the deduplication techniques of the present application may be applicable to a virtual computer system environment. In such an environment, instead of executing software applications directly on a computer system, an intermediate software application sometimes called a hypenrisor can be incorporated into the system. In this case, software applications need not execute on a real physical machine (computer) but instead can execute on a simulated computer, called a virtual machine.

The virtual computer system environment can include a server computer running several virtual machines, for example. The virtual system environment can simulate a real machine including simulated disk storage for the simulated machine. The simulated disk storage may take the form of virtual disk images, which may include the content of the simulated disk storage. Such a system may include a server running virtual machines coupled to dumb terminals which may be computing devices that simply display data and provide a keyboard for entering data. The dumb terminals may rely on having most of the computing work performed on the server in the form of virtual machines. Each of the virtual machines can have virtual disk images that may have similar content. For example, the virtual disk images may include applications such as operating systems and device drivers that may be the same on each of the virtual machines. In one example, computer system 100 may receive data from data stream 102 that may include writes or updates to virtual disk images. The virtual disk images can be in the form of data blocks that may already be divided along block boundaries. The virtual machines running on the servers may be sending data to computer system 100 as well as requesting data from computer system 100. In this case, computer system 100 can deduplicate the data blocks that make up the virtual disk images.

In another example, the deduplication techniques of the present application may be applicable to computer backup environments. In this case, computer system 100 may receive data from data stream 102 that may need to be divided along block boundaries (i.e., chunking).

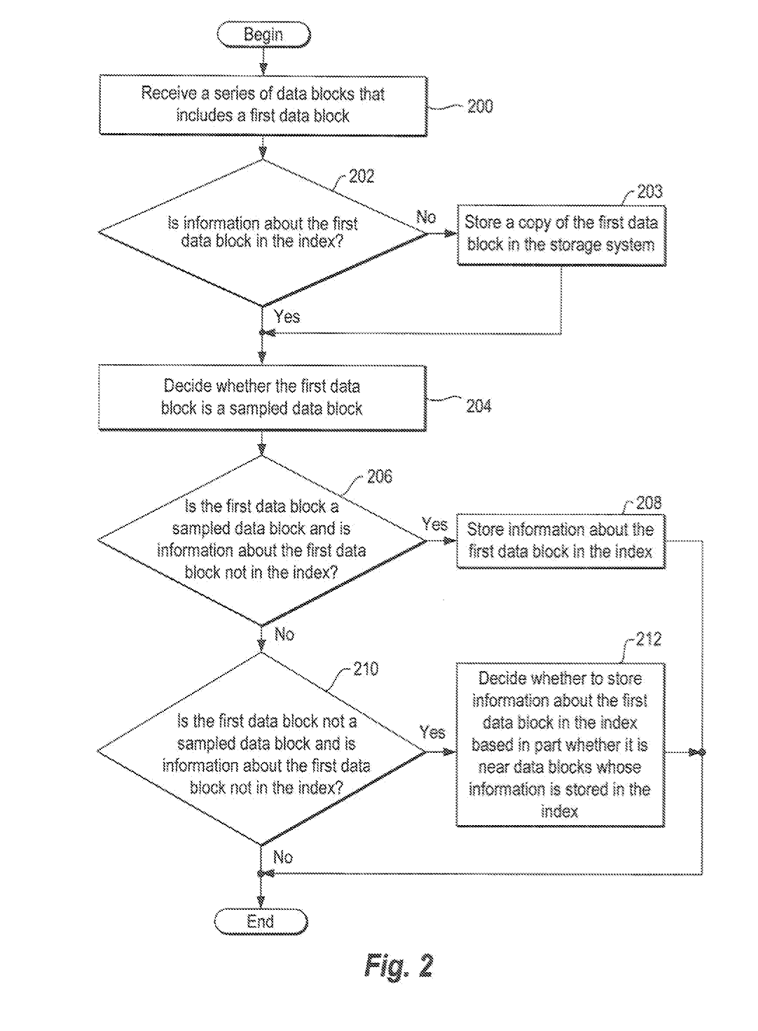

FIG. 2 shows a flow diagram of a method of processing data blocks using computer system 100 of FIG. 1, in accordance with an example of the present application. To illustrate, it will be assumed that computer system 100 can receive data blocks from data stream 102 and store information about the data blocks in index 114. It can be further assumed that computer system 100 can store data from data stream 102 as data blocks 116 in storage system 104.

At block 200, computer system 100 receives a series of data blocks that includes a first data block for subsequent processing. For example, receiver module 106 can receive data blocks from data stream 102 for subsequent processing by sampling module 108 and indexer module 110. Alternatively, receiver module 106 can divide data received from data stream 102 into one or more data blocks, including the first data block.

At block 202, computer system 100 checks whether information about the first data block is found in index 114. If information about the first data block is found in index 114, then processing proceeds to block 204 as explained below. On the other hand, if information about the first data block is not found in index 114, then processing proceeds to block 203 where computer system 100 stores a copy of the first data block to storage system 104. Once computer system 100 stores a copy of the first data block to storage system 104, processing proceeds to block 204 as explained below.

At block 204, computer system 100 decides whether the first data block is a sampled data block. For example, sampling module 108 can decide whether the first data block is a sampled data block by checking whether a hash value of the first data block has a predetermined characteristic. The hash value can be used by indexer module 110 for subsequent processing. For example, in block 206 below, indexer module 110 can use the hash value to determine whether information about the first data block is stored in index 114. Although sampling module 108 is described as being able to decide whether the first data block is a sampled data block, it should be understood that the sampling module is capable of deciding whether any of the data blocks are sampled data blocks.

At block 206, computer system 100 checks whether the first data block is a sampled data block and whether information about the first data block is not stored in index 114. For example, as explained above, sampling module 108 can determine whether a data block is a sampled data block by checking whether a hash value of the data block has a predetermined characteristic. In another example, indexer module 110 can calculate a hash value based on the data block and use it to check whether information about the first data block is stored in index 114. If indexer module 110 determines that the first data block is a sampled data block and that information about the first data block is not stored in index 114, then this indicates that information about this data block is to be stored in the index. In this case, processing proceeds to block 208 as explained below. On the other hand, if indexer module 110 determines that the first data block is not a sampled data block or information about the first data block is not stored in index 114, then processing proceeds to block 210 for further processing.

At block 208, indexer module 110 stores information about the first data block in index 114. In one example, information about the first data block can include the hash value of the data block. The indexer module 110 can store additional information in index 114 such as a physical address of the corresponding data block 116 in storage system 104. This address information can be used for subsequent deduplication of incoming data blocks. Once indexer module 110 stores information about the first data block in index 114, processing exits.

At block 210, computer system 100 checks whether the first data block is not a sampled data block and whether information about the first data block is not stored in index 114. If indexer module 110 determines that the first data block is not a sampled data block and that information about the data block is not stored in index 114, then processing proceeds to block 212 to have computer system 100 decide whether or not to store information about the first data block in the index, as explained below in further detail. On the other hand, if indexer module 110 determines that the first data block is either a sampled data block or information of the data block is already stored in stored in index 114, then processing exits.

At block 212, computer system 100 decides whether to store information about the first data block in index 114 based in part on whether it is near data blocks whose information is stored in the index. The indexer module 110 can determine which data blocks of the series of data blocks both have information in the index 114 and are near the first data block. It can use this information to help make its decision. For example, indexer module 110 can decide whether the first data block is near other data blocks whose information is stored in index 114 by checking whether the first data block is within a predetermined distance of a data block of one of the series of data blocks whose information is in the index. That is, computer system 100 checks whether there exists a data block of the series of data blocks that both has information about it in index 114 and is within a predetermined distance of the first data block.

In another example, indexer module 110 can decide whether the first data block is near data blocks whose information is stored in index 114 by checking whether the first data block is near at least a predetermined number of data blocks of the series of the data blocks whose information is stored in the index. That is, computer system 100 checks whether there exists at least a predetermined number of data blocks of the series of data blocks that both have information about them in index 114 and are within a predetermined distance of the first data block. As explained above, the location related parameters, such as the predetermined distance or predetermined number of data blocks, can include any number of data blocks such, as ten data blocks, and can be based on various factors related to the characteristics of the data blocks.

Although FIG. 2 describes the processing of only the first data block, it should be understood that blocks 202 onwards would be repeated with the first data block being replaced by the second data block on the second iteration, the third data block on the third iteration, etc., until all the data blocks of the series of data blocks have been processed.

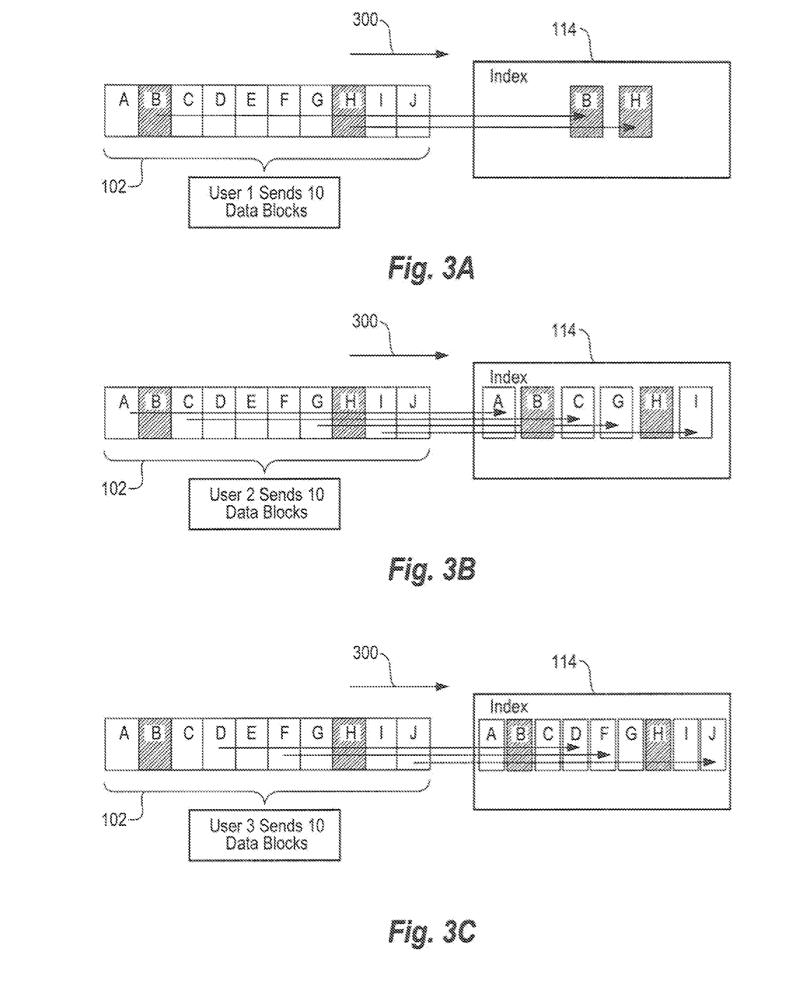

FIGS. 3A-3C are diagrams showing an example of processing data with computer system 100 for deduplication. To illustrate, it will be assumed that computer system 100 can receive data blocks from data stream 102 and decide whether to store information about the data blocks in index 114. It will be further assumed that computer system 100 can store pieces of the data as data blocks 116 in storage system 104. In addition, in this example, it will be further assumed that data stream 102 provides a sequence of 30 data blocks that consists of the same 10 data block sequence (Block A through Block J) repeated three times because these 10 data blocks are sent to computer system 100 by three different users referred to as User 1, User 2, and User 3. For example, the 10 data blocks can be part of the same electronic document, such as email content, that each of the users has received from their manager. To illustrate operation, it will be further assumed that sampling module 108 can make decisions about whether a data block is a sampled data block. In addition, it can be assumed that indexer module 110 can make decisions about whether information of a data block (such as a hash value of the data block) is stored in index 114.

It will be further assumed that there are two data blocks (Blocks B and H) among the 10 data blocks that have hashes with the predetermined characteristic (depicted by shading) that causes the sampling module 108 to decide that they are sampled data blocks. It can be also assumed that receiver module 106 can receive data blocks from data stream 102 and that storing module 112 can decide whether to store pieces of the received data blocks as data blocks 116 in storage system 104. It should be understood, however, that the above is for illustrative purposes and that a different number of data blocks can be used and that a different number of users can provide the data blocks, for example.

Referring to FIG. 3A, User 1 is the first to send the 10 data blocks (Block A through Block J) to computer system 100. The sampling module 108 can process each of the 10 data blocks (Block A through Block J) and determine whether any of the data blocks is a sampled data block. In addition, indexer module 110 can determine whether information about any of the data blocks is stored in index 114. In one example, sampling module 108 can determine whether a data blocks is a sampled data block by checking whether a hash value of the data block has a predetermined characteristic. It will be further assumed, to illustrate, that this is the first time that computer system 100 has received the 10 data blocks (Block A through Block J). In this case, index 114 will not contain information (such as a hash value and a physical address) about any of the 10 data blocks (Block A through Block J). Accordingly, indexer module 110 will find that there is no information about the 10 data blocks stored in index 114.

In this example, sampling module 108 determines that only two data blocks. Blocks B and H, are sampled data blocks and that the remaining data blocks are not sampled data blocks. The indexer module 110 determines that Information about Blocks B or H is not stored in index 114 and therefore it will store information about these data blocks in the index, as shown generally by arrow 300 in FIG. 3A. Furthermore, because this is the first time that the 10 data blocks were received by computer system 100, the computer system will store a copy of the 10 data blocks in storage system 104. In addition, because this is the first time that the 10 data blocks were received, deduplication does not take place because none of the data blocks were found to be duplicate data blocks.

Turning to FIG. 3B, after User 1 sent the 10 data blocks (Block A through Block J), User 2 then sends 10 data blocks to computer system 100. The data blocks from User 2 are the same data blocks as sent by User 1 in FIG. 3A above. The sampling module 108 and indexer module 110 can perform the same process as explained above in connection with FIG. 3A.

In this example, this is the second time that sampling module 108 has received the 10 data blocks (Block A through Block J). In this case, sampling module 108 determines that Blocks B and H are sampled data blocks because their hashes have the predetermined characteristic. The indexer module 110 determines that information about Blocks B and H is already stored in index 114 and therefore the system does not need to store additional copies of this information in the index. In addition, computer system 100 does not have to store another copy of Blocks B and H in storage system 104 because information about these data blocks was previously stored in index 114 by indexer module 110. That is, deduplication takes place for Blocks B and H because these data blocks were found to be duplicate data blocks and therefore do not need to be stored again in storage system 104.

Continuing with this example, sampling module 108 determines that the remaining data blocks (Blocks A, C-G, and I-J) are not sampled data blocks. The indexer module 110 also determines that information about these remaining data blocks is not stored in index 114. In this case, indexer module 110 decides whether to store information about these data blocks in index 114 based in part on whether they are near data blocks whose information is stored in the index. The indexer module 110 can determine location (locality) related information about the remaining data blocks (Blocks A. C-G and I-J) relative to other data blocks stored in index 114. In one example, indexer module 110 can decide whether any of the remaining data blocks are near data blocks whose information is stored in index 114 by checking whether any of the remaining data blocks is within a predetermined distance of a data block of one of the series of data blocks whose information is in the index. To illustrate, it will be assumed that the predetermined distance has been set to be one data block from one of the data blocks whose information is stored in index 114. In this case, sampled data blocks Block B and H are the data blocks whose information is stored in index 114. In this case, indexer module 110 determines that four of the remaining data blocks (Blocks A, C, G, and I) are within the predetermined distance of one data block from one of the sampled data blocks Block B and H. Indexer module 110 will then store the information of these data blocks (Blocks A, C, G, and I) in index 114, as shown generally by arrow 300 in FIG. 3B. Furthermore, because this is the second time that these data blocks were received by computer system 100, storing module 112 will store a second copy of the remaining data blocks (Blocks A, C-G, and I-J) in storage system 104. That is, storing module 112 will need to store a second copy of these data blocks in storage system 104 because information about these data blocks was not previously stored in index 114. That is, deduplication does not take place for these data blocks (Blocks A, C-G, and I-J) because these data blocks were not found to be duplicate data blocks and therefore need to be stored again in storage system 104.

At FIG. 3C, User 3 then sends 10 data blocks (Block A through Block J) to computer system 100. The data blocks from User 3 are the same data blocks as sent by User 1 in FIG. 3A and by User 2 in FIG. 3B above.

In this example, this is the third time that sampling module 108 has received the 10 data blocks (Block A through Block J). In this case, sampling module 108 determines that Blocks B and H are sampled data blocks because their hashes have the predetermined characteristic. The indexer module 110 determines that information about Blocks B and H are already stored in index 114 and therefore does not need to store another copy of their information in the index. In addition, computer system 100 does not have to store additional copies of Blocks B and H in storage system 104 because information about these data block was previously stored in index 114 by indexer module 110. That is, deduplication takes place for Blocks B and H because these data blocks were found to be duplicate data blocks and therefore do not need to be stored again in storage system 104.

Continuing with this example, sampling module 110 determines that Blocks A, C, G, and I are not sampled data blocks. However, indexer module 110 determines that information about Blocks A, C, G, and I is already stored in index 114 and therefore it does not need to store another copy of this information in the index. In addition, computer system 100 does not have to store another copy of Blocks A, C, G, and I in storage system 104 because information about these data blocks was previously stored in index 114 by indexer module 110. That is, deduplication takes place for Blocks A, C, G, and I because these data blocks were found to be duplicate data blocks and therefore do not need to be stored again in storage system 104.

Continuing with this example, sampling module 110 determines that the remaining data blocks (Blocks D-F and J) are not sampled data blocks. Indexer module 110 then determines that information about these remaining data blocks is not stored in index 114. In this case, indexer module 110 decides whether to store information about these data blocks in index 114 based in part on whether they are near data blocks whose information is stored in the index. The indexer module 110 can determine location (locality) related information about data blocks relative to other data blocks stored in index 114. In one example, indexer module 110 can decide whether these data blocks are near data blocks whose information is stored in index 114 by checking whether these data blocks are within a predetermined distance of a data block of one of the series of data blocks whose information is in the index. As explained above, to illustrate, it will be assumed that a predetermined distance is set to one data block from a data block whose information is stored in index 114. In this case, Blocks A-C and G-I have information about them stored in index 114. Indexer module 110 determines that Blocks D, G and J are within a predetermined distance of one data block from one of Blocks A-C and G-I. Indexer module 110 stores information about Blocks D, G, and J in index 114, as shown generally by arrow 300 in FIG. 3C. Furthermore, because this is the third time that data blocks A, D-F, and J were received by computer system 100, the computer system will store a third copy of these data blocks in storage system 104. That is, storing module 112 will need to store a third copy of these data blocks (Blocks A, D-F, and J), in storage system 104 because information about these data blocks was not previously stored in index 114.

As may be shown in the example above in the context of FIGS. 3A through 3C, the more times the same data blocks are received, the more of the data blocks will have their information stored in index 114 by indexer module 110, and the more duplicates that are found which do not need to be stored in storage system 104. That is, the more often the same data is received, the less the number of copies of the data blocks that need to be stored in the storage system because information about the data blocks was previously stored in index 114.

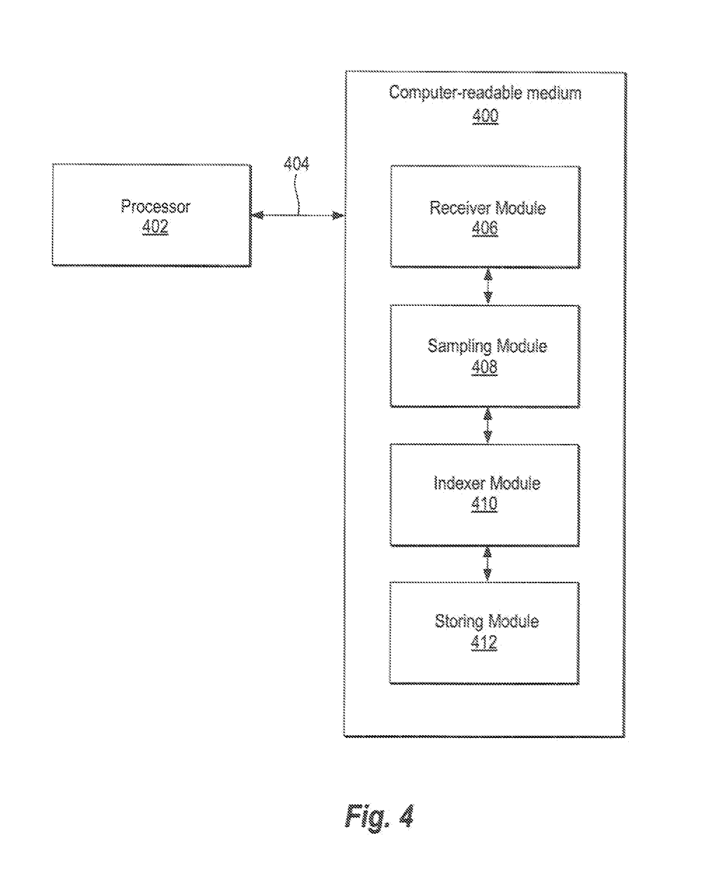

FIG. 4 is a block diagram showing a non-transitory, computer-readable medium that stores code for processing data for deduplication in accordance with embodiments. The non-transitory, computer-readable medium is generally referred to by the reference number 400 and may be included in computer system 100 in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

One or more processors 402 generally retrieve and execute the instructions stored in the non-transitory, computer-readable medium 400 to operate computer system 100 in accordance with embodiments. In an embodiment, the tangible, machine-readable medium 400 can be accessed by processor 402 over a bus 404. A region 406 of the non-transitory, computer-readable medium 400 may include receiver module 106 functionality as described herein. Another region 408 of non-transitory, computer-readable medium 400 may include sampling module 108 functionality as described herein. Another region 410 of non-transitory, computer-readable medium 400 may include indexer module 110 functionality as described herein. Region 412 of non-transitory, computer-readable medium 400 may include storing module 112 functionality as described herein.

Although shown as contiguous blocks, the software components can be stored in any order or configuration. For example, if the non-transitory, computer-readable medium 400 is a hard drive, the software components can be stored in non-contiguous, or even overlapping, sectors.

In the foregoing description, numerous details are set forth to provide an understanding of the present example invention. However, it will be understood by those skilled in the art that the present example invention may be practiced without these details. While the example invention has been disclosed with respect to a limited number of embodiments, those skilled in the art will appreciate numerous modifications and variations there from. It is intended that the appended claims cover such modifications and variations as fall within the true spirit and scope of the example invention.

1. A computer system for deduplication comprising:
an index to store information about data blocks;
a receiver module to receive a series of data blocks that includes a first data block; and
an indexer module to:
if the first data block is a sampled data block and information about the first data block is not in the index, store information about the first data block in the index, and
if the first data block is not a sampled data block and information about the first data block is not in the index, decide whether to store information about the first data block in the index based in part on whether it is near data blocks whose information is stored in the index.

2. The computer system of claim 1, wherein a sampling module is configured to decide whether the first data block is a sampled data block by checking whether a hash value of the first data block has a predetermined characteristic.

3. The computer system of claim 1, wherein the indexer module is configured to decide whether the first data block is near data blocks whose information is stored in the index by checking whether the first data block is within a predetermined distance of one of the series of data blocks whose information is in the index.

4. The computer system of claim 1, wherein the indexer module is configured to decide whether the first data block is near data blocks that are in the index by checking whether the first data block is near at least a predetermined number of data blocks of the series of data blocks whose information is stored in the index.

5. The computer system of claim 1, wherein the indexer module is further configured to remove information about a non-sampled data block from the index if it has been stored in the index for a predetermined period of time.

6. The computer system of claim 1, wherein the indexer module is further configured to remove information about a random non-sampled data block from the index.

7. A method of deduplication comprising:
receiving a series of data blocks that includes a first data block;
deciding whether the first data block is a sampled data block;
if the first data block is a sampled data block and information about the first data block is not in the index, storing information about the first data block in the index; and
if the first data block is not a sampled data block and information about the first data block is not in the index, deciding whether to store information about the first data block in the index based in part on whether it is near data blocks whose information is stored in the index.

8. The method of claim 7, wherein deciding whether the first data block is a sampled data block further comprises checking whether a hash value of the first data block has a predetermined characteristic.

9. The method of claim 7, wherein deciding whether the first data block is near data blocks that are in the index further comprises checking whether the first data block is within a predetermined distance of a data block of one of the series of data blocks whose information is in the index.

10. The method of claim 7, further comprising removing information about a non-sampled data block from the index if it has been stored in the index for a predetermined period of time.

11. The method of claim 7, further comprising removing information about a random non-sampled data block from the index.

12. A non-transitory computer readable medium comprising code for deduplication that if executed causes a processor to:
receive a series of data blocks that includes a first data block;
decide whether the first data block is a sampled data block;
if the first data block is a sampled data block and information about the first data block is not in the index, store information about the first data block in the index; and
if the first data block is not a sampled data block and information about the first data block is not in the index, decide whether to store information about the first data block in the index based in part on whether it is near data blocks whose information is stored in the index.

13. The computer readable medium of claim 12 further comprising code that if executed causes a processor to:
decide whether the first data block is a sampled data block by checking whether a hash value of the first data block has a predetermined characteristic.

14. The computer readable medium of claim 12 further comprising code that if executed causes a processor to:
decide whether the first data block is near data blocks that are in the index by checking whether the first data block is within a predetermined distance of a data block of one of the series of data blocks whose information is in the index.

15. The computer readable medium of claim 12 further comprising code that if executed causes a processor to:
remove information about a non-sampled data block from the index if it has been stored in the index for a predetermined period of time.
